(19) United States
(12) Patent Application Publication
(10) Pub. No.: US 2022/0022036 A1
(43) Pub. Date: Jan. 20, 2022

(54) SECURITY VERIFICATION METHOD AND SYSTEM, COMPUTER DEVICE AND MEDIUM

(71) Applicant: BOE Technology Group Co., Ltd., Beijing (CN)

(72) Inventor: Hongyun MAN, Beijing (CN)

(21) Appl. No.: 17/296,866

(22) PCT Filed: Aug. 28, 2020
(86) PCT No.: PCT/CN2020/112208

§ 371 Date: May 25, 2021

(30) Foreign Application Priority Data
Sep. 19, 2019 (CN) 201910886855.1

(51) Int. Cl. H04W 12/06; H04L 9/32; H04W 76/10; H04L 12/18

(52) U.S. Cl. CPC H04W 12/06; H04L 9/3236; H04L 2209/80; H04W 76/10; H04L 12/189; H04L 9/3239

(57) ABSTRACT

Disclosed are a security verification method, a security verification system, a computer-readable storage medium and a computer device. The security verification method includes: receiving a socket connection request from a mobile control device to establish a socket connection with the mobile control device; receiving control information from the mobile control device, where the control information includes a control command and an authentication parameter, the authentication parameter includes authorization information of the mobile control device in the mobile control device, and the authorization information is acquired by the mobile control device from the controlled device when the mobile control device is connected with the controlled device through wireless communication; and verifying the authorization information, and executing the control command in response to verification success and returning verification failure otherwise.

### CROSS-REFERENCE TO RELATED APPLICATIONS

The present disclosure claims a priority of the Chinese patent application No. 201910886855.1 filed on Sep. 19, 2019 and entitled “SECURITY VERIFICATION METHOD AND SYSTEM FOR COMMUNICATION DEVICE, COMPUTER DEVICE AND MEDIUM”, which is incorporated herein by reference in its entirety.

### TECHNICAL FIELD

The present disclosure relates to the field of communication technology, and in particular to a security verification method, a security verification system, a non-transitory computer-readable storage medium, and a computer device.

### BACKGROUND

In application scenarios of remote communication between existing communication devices, a mobile control device is typically used to set and control a controlled device, for example, the mobile control device is used to set and control operation modes and states of the controlled device. However, in the related art, the mobile control device typically communicates with the controlled device directly through a wireless network, ignoring identity verification of the mobile control device. Therefore, it is easy for an illegal mobile control device to access the controlled device and remotely control the controlled device maliciously.

### SUMMARY

A first aspect of the present disclosure provides a security verification method applied to a controlled device, including: receiving a socket connection request from a mobile control device to establish a socket connection with the mobile control device; receiving control information from the mobile control device, where the control information includes a control command and an authentication parameter, the authentication parameter includes authorization information of the mobile control device in the mobile control device, and the authorization information is acquired by the mobile control device from the controlled device when the mobile control device is connected with the controlled device through wireless communication technology; and verifying the authorization information, and executing the control command in response to verification success and returning verification failure otherwise.

Optionally, before receiving the socket connection request from the mobile control device to establish the socket connection with the mobile control device, the security verification method may further include: broadcasting a wireless communication signal; receiving an identity identifier of the mobile control device; generating and storing the authorization information of the mobile control device according to the identity identifier; and sending the authorization information and identification information representing an identity of the controlled device to the mobile control device.

Optionally, generating and storing the authorization information of the mobile control device according to the identity identifier may further include: generating a signature of the mobile control device according to the identity identifier and a first receiving time when the identity identifier is received; storing the signature and the first receiving time; and generating and storing the authorization information according to the signature.

Optionally, generating and storing the authorization information according to the signature may further include: generating a first encrypted signature according to the signature through a message digest algorithm; generating an encrypted random number according to a randomly generated random number through the message digest algorithm, and generating a second encrypted signature in combination with the first encrypted signature; and generating and storing the authorization information according to the second encrypted signature through the message digest algorithm.

Optionally, before storing the signature and the first receiving time, the security verification method may further include: determining whether the signature, the first receiving time and the authorization information of the mobile control device are stored, and in response to determining that the signature, the first receiving time and the authorization information of the mobile control device are stored, deleting the signature, the first receiving time and the authorization information stored.

Optionally, verifying the authorization information, and executing the control command in response to verification success and returning verification failure otherwise, may further include: comparing the stored authorization information of the mobile control device with the authorization information in the authentication parameter; in response to the stored authorization information of the mobile control device being the same as the authorization information in the authentication parameter, comparing, by the controlled device, the stored first receiving time with a second receiving time when the control information is received, and executing the control command in response to the first receiving time and the second receiving time satisfying a preset time range and returning the verification failure otherwise; and in response to the stored authorization information of the mobile control device being different from the authorization information in the authentication parameter, returning the verification failure.

Optionally, the wireless communication technology may be one of Bluetooth, ZigBee, Lora, radio frequency near field communication, and infrared communication.

A second aspect of the present disclosure provides a security verification method applied to a mobile control device, including: sending a socket connection request to a controlled device according to identification information of the controlled device to establish a socket connection with the controlled device; and sending control information to the controlled device, where the control information includes a control command and an authentication parameter, the authentication parameter includes authorization information of the mobile control device in the mobile control device, and the authorization information is acquired by the mobile control device from the controlled device when the mobile control device is connected with the controlled device through wireless communication technology, and where the controlled device verifies the authorization information to execute the control command.

Optionally, before sending the socket connection request to the controlled device according to the identification information of the controlled device to establish the socket connection with the controlled device, the security verification method may further include: searching for and detecting a wireless communication signal broadcast by the controlled device to be connected, and connecting with the controlled device; transmitting an identity identifier to the controlled device through the wireless communication signal, such that the controlled device generates and stores the authorization information of the mobile control device according to the identity identifier; and receiving and storing the authorization information and the identification information representing an identity of the controlled device from the controlled device.

A third aspect of the present disclosure provides a security verification method, including: sending a socket connection request, by a mobile control device, to a controlled device; receiving, by the controlled device, the socket connection request to establish a socket connection with the mobile control device; sending, by the mobile control device, control information to the controlled device, where the control information includes a control command and an authentication parameter, the authentication parameter includes authorization information of the mobile control device in the mobile control device, and the authorization information is acquired by the mobile control device from the controlled device when the mobile control device is connected with the controlled device through wireless communication technology; and verifying, by the controlled device, the authorization information, and executing the control command in response to verification success and returning verification failure otherwise.

Optionally, before sending the socket connection request, by the mobile control device, to the controlled device, the security verification method may further include: broadcasting, by the controlled device, a wireless communication signal; searching for and detecting, by the mobile control device, the wireless communication signal broadcast by the controlled device to be connected, and connecting with the controlled device; transmitting, by the mobile control device, an identity identifier to the controlled device; generating and storing, by the controlled device, the authorization information of the mobile control device according to the identity identifier; and sending, by the controlled device, the authorization information and identification information representing an identity of the controlled device, to the mobile control device.

Optionally, generating and storing, by the controlled device, the authorization information of the mobile control device according to the identity identifier, may further include: generating, by the controlled device, a signature of the mobile control device according to the identity identifier and a first receiving time when the identity identifier is received; storing, by the controlled device, the signature and the first receiving time; and generating and storing, by the controlled device, the authorization information according to the signature.

Optionally, generating and storing, by the controlled device, the authorization information according to the signature, may further include: generating, by the controlled device, a first encrypted signature according to the signature through a message digest algorithm; generating, by the controlled device, an encrypted random number according to a randomly generated random number through the message digest algorithm, and generating a second encrypted signature in combination with the first encrypted signature; and generating and storing, by the controlled device, the authorization information according to the second encrypted signature through the message digest algorithm.

Optionally, before storing, by the controlled device, the signature and the first receiving time, the security verification method may further include: determining, by the controlled device, whether the signature, the first receiving time and the authorization information of the mobile control device are stored, and in response to determining that the signature, the first receiving time and the authorization information of the mobile control device are stored, deleting the signature, the first receiving time and the authorization information stored.

Optionally, verifying, by the controlled device, the authorization information, and executing the control command in response to verification success and returning verification failure otherwise, may further include: comparing, by the controlled device, the stored authorization information of the mobile control device with the authorization information in the authentication parameter; in response to the stored authorization information of the mobile control device being the same as the authorization information in the authentication parameter, comparing, by the controlled device, the stored first receiving time with a second receiving time when the control information is received, and executing the control command in response to the first receiving time and the second receiving time satisfying a preset time range and returning the verification failure otherwise; and in response to the stored authorization information of the mobile control device being different from the authorization information in the authentication parameter, returning the verification failure.

Optionally, the wireless communication technology may be one of Bluetooth, ZigBee, Lora, radio frequency near field communication, and infrared communication.

A fourth aspect of the present disclosure provides a security verification system, including a controlled device and a mobile control device, where the mobile control device is configured to send a socket connection request to the controlled device to establish a socket connection with the controlled device, and send control information to the controlled device, where the control information includes a control command and an authentication parameter, the authentication parameter includes authorization information of the mobile control device in the mobile control device, and the authorization information is acquired by the mobile control device from the controlled device when the mobile control device is connected with the controlled device through wireless communication technology; and the controlled device is configured to verify the authorization information, and execute the control command in response to verification success and return verification failure otherwise.

A fifth aspect of the present disclosure provides a non-transitory computer-readable storage medium in which a computer program is stored, where when the computer program is executed by a processor, the security verification method according to the first aspect is performed; or when the computer program is executed by a processor, the security verification method according the second aspect is performed.

A sixth aspect of the present disclosure provides a computer device, including a memory, a processor, and a computer program stored in the memory and executable in the processor, where the processor performs the security verification method according to the first aspect when executing the computer program; or the processor performs the security verification method according to the second aspect when executing the computer program.

### BRIEF DESCRIPTION OF THE DRAWINGS

Embodiments of the present disclosure will be described in further detail below with reference to the accompanying drawings.

FIG. 1 illustrates a flowchart of a security verification method according to an embodiment of the present disclosure;

FIG. 2 illustrates a swim-lane diagram of a security verification method according to an embodiment of the present disclosure;

FIG. 3 illustrates a flowchart of a security verification method according to another embodiment of the present disclosure;

FIG. 4 illustrates a flowchart of a security verification method according to yet another embodiment of the present disclosure;

FIG. 5 illustrates a structural block diagram of a security verification system according to an embodiment of the present disclosure; and

FIG. 6 illustrates a schematic structural diagram of a computer device according to another embodiment of the present disclosure.

### DETAILED DESCRIPTION OF THE EMBODIMENTS

In order to explain the present disclosure more clearly, the present disclosure will be further described below in conjunction with preferred embodiments and drawings. Similar components in the drawings are denoted by the same reference numerals. Those skilled in the art should understand that contents specifically described below are illustrative rather than restrictive, and should not be used to limit the protection scope of the present disclosure.

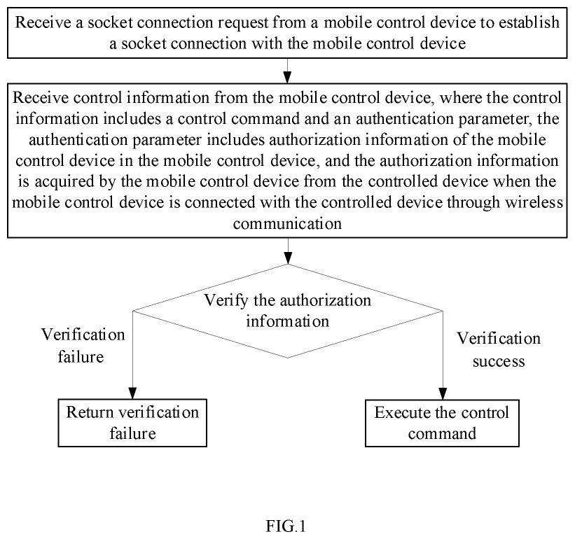

As shown in FIG. 1, an embodiment of the present disclosure provides a security verification method applied to a controlled device, including: receiving a socket connection request from a mobile control device to establish a socket connection with the mobile control device; receiving control information from the mobile control device, where the control information includes a control command and an authentication parameter, the authentication parameter includes authorization information of the mobile control device in the mobile control device, and the authorization information is acquired by the mobile control device from the controlled device when the mobile control device is connected with the controlled device through wireless communication technology; and verifying the authorization information, and executing the control command in response to verification success and returning verification failure otherwise.

In this embodiment, the mobile control device is first connected with the controlled device through the wireless communication technology, and acquires the authorization information of the mobile control device from the controlled device, that is, with a short-range connection and secure connection mechanism of the wireless communication technology, the controlled device determines an identity of the mobile control device, and the mobile control device acquires the authorization information from the controlled device; then, the mobile control device establishes the socket connection with the controlled device and sends the authorization information to the controlled device, and the controlled device verifies the identity of the mobile control device by the received authorization information, so as to prevent an illegal mobile control device from accessing the controlled device and controlling the controlled device maliciously.

Therefore, in an optional embodiment, before receiving the socket connection request from the mobile control device to establish the socket connection with the mobile control device, the security verification method may further includes: broadcasting a wireless communication signal; receiving an identity identifier of the mobile control device; generating and storing the authorization information of the mobile control device according to the identity identifier; and sending the authorization information and identification information representing an identity of the controlled device to the mobile control device.

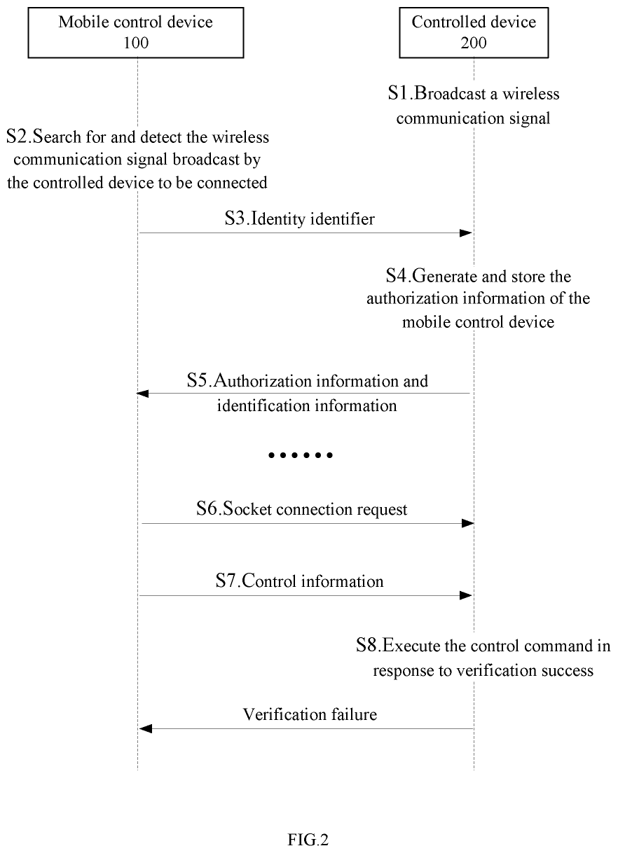

In an example, the mobile control device may be used to remotely control the controlled device. The mobile control device may be a tablet computer, and the controlled device may be a medical device such as a medical examination device, and in this case, the tablet computer may be used to control the medical device. For example, the tablet computer may be used to remotely control parameters of the medical device, for example, the tablet computer may be used to set a screen display mode, split-screen display or single-screen display, screen brightness, volume, angle and focal length of a camera of the medical device, etc. As shown in FIG. 2, an embodiment of this example is as follows.

S1: The controlled device 200 broadcasts a wireless communication signal.

Short-range wireless connection may be enabled between the mobile control device and the controlled device through the wireless communication technology, and the wireless communication technology may be one of Bluetooth, ZigBee, Lora, radio frequency near field communication, and infrared communication. In this embodiment, the wireless communication technology is Bluetooth technology, the wireless communication signal is a Bluetooth signal, and the medical device turns on its own Bluetooth and periodically broadcasts the Bluetooth signal. That is, the controlled device broadcasts the wireless communication signal to enable the mobile control device to access.

S2: The mobile control device 100 searches for and detects the wireless communication signal broadcast by the controlled device 200 to be connected, and connects with the controlled device 200.

In this embodiment, the mobile control device 100 is a tablet computer, though the mobile control device 100 may be another mobile control device such as a smart phone. The tablet computer may enable Bluetooth and search for connectable Bluetooth devices, and may connect with the controlled device 200 to be connected upon detecting the Bluetooth signal sent from the controlled device 200.

S3: The mobile control device transmits an identity identifier to the controlled device.

In this embodiment, the identity identifier is a physical address (MAC) of the mobile control device, and the physical address may uniquely characterize the mobile control device.

S4: The controlled device generates and stores the authorization information of the mobile control device according to the identity identifier.

In this embodiment, the controlled device generates a signature representing identity verification information of the mobile control device according to the received physical address of the mobile control device. In order to prevent the signature from being deciphered, the signature is further encrypted to generate an encrypted signature. That is, the controlled device receives the identity identifier of the mobile control device, and generates and stores the authorization information of the mobile control device according to the identity identifier.

In an optional embodiment, generating and storing, by the controlled device, the authorization information of the mobile control device according to the identity identifier may further include the following operations.

Firstly, the controlled device generates a signature of the mobile control device according to the identity identifier and a first receiving time when the identity identifier is received.

In this embodiment, the signature may be obtained by a predetermined calculation method according to the physical address that uniquely characterizes the mobile control device and a system time when the controlled device receives the physical address of the mobile control device.

Secondly, the controlled device stores the signature and the first receiving time.

In this embodiment, in order to facilitate subsequent authentication process of the controlled device, the signature and the first receiving time may be stored.

Thirdly, the controlled device generates and stores the authorization information according to the signature.

In this embodiment, in order to prevent the signature from being deciphered due to a simple calculation method for the signature, the signature may be encrypted through a message digest algorithm to generate the authorization information and save the authorization information, thereby enabling security protection for the signature.

When the signature is encrypted only through the message digest algorithm to generate the authorization information, the signature is still at risk of being deciphered to a certain extent. Considering this, in an optional embodiment, generating and storing the authorization information according to the signature may further include the following operations.

1) A first encrypted signature is generated according to the signature through a message digest algorithm.

2) An encrypted random number is generated according to a randomly generated random number through the message digest algorithm, and a second encrypted signature is generated according to the encrypted random number in combination with the first encrypted signature.

In this embodiment, considering that there may be security risks in using the message digest algorithm for encryption, the random number may be randomly generated at the controlled device side, encrypted with the message digest algorithm, and combined with the first encrypted signature to generate the second encrypted signature.

3) The authorization information is generated and stored according to the second encrypted signature through the message digest algorithm.

In this embodiment, in order to enhance undecipherability of the authorization information, the controlled device re-encrypts the second encrypted signature to generate the authorization information, which is stored in the controlled device. Since the random number is randomly generated, and there is no possibility of reproduction, a possibility that the authorization information generated through the above operations is deciphered may be effectively reduced.

Taking into account that the controlled device may have stored information records of the signature and authorization information of the mobile control device (in this embodiment, the tablet computer) connected at the present time, in order to simplify the subsequent authentication process of the controlled device, in an optional embodiment, before storing the signature and the first receiving time, the method may further include: determining whether the signature, the first receiving time and the authorization information of the mobile control device are stored, and in response to determining that the signature, the first receiving time and the authorization information of the mobile control device are stored, deleting the signature, the first receiving time and the authorization information stored.

In this embodiment, there may be multiple wireless communication connections during remote control of the controlled device using the mobile control device, and the signature, and the corresponding access time and authorization information may be saved according to the identity identifier of the mobile control device during each connection for subsequent authentication. As a result, a large amount of signatures, access time and authorization information about the mobile control device may have been stored in the controlled device. Since the authentication process itself is time-efficient, in order to simplify the authentication process and avoid confusion caused by the information stored previously, when storing the signature of the mobile control device connected at the present time and the corresponding first receiving time, the controlled device detects whether the signature, the first receiving time and the authorization information corresponding to the mobile control device are stored in the controlled device, and if so, deletes the signature, the first receiving time and the authorization information stored and then stores the signature, the first receiving time and the authorization information corresponding to the mobile control device connected at the present time, otherwise stores them directly. In this way, the accuracy of the signature, the first receiving time and the authorization information stored in the controlled device side may be ensured.

S5: The controlled device sends the authorization information and identification information representing an identity of the controlled device to the mobile control device.

In this embodiment, the identification information is an IP address of the controlled device, which may uniquely represent the identity of the controlled device. The controlled device sends the calculated authorization information and its own IP address to the mobile control device via Bluetooth, such that the mobile control device may connect with the controlled device through wireless communication according to the IP address. That is, the controlled device sends the authorization information and the identification information representing the identity of the controlled device to the mobile control device.

So far, the controlled device and the mobile control device acquire the authorization information for use in subsequent authentication process via a short-range connection through the wireless communication technology.

Then, the controlled device and the mobile control device are connected through a socket, and complete the authentication process according to the authorization information and realize secure transmission of the control information.

S6: The mobile control device sends a socket connection request to the controlled device according to the identification information to establish a socket connection with the controlled device.

In this embodiment, the mobile control device may send the socket connection according to the IP address of the controlled device to establish the socket connection with the controlled device. That is, the controlled device receives the socket connection request from the mobile control device to establish the socket connection with the mobile control device.

S7: The mobile control device sends control information to the controlled device, where the control information includes a control command and an authentication parameter, and the authentication parameter includes the authorization information.

In this embodiment, the mobile control device may send the control information to the controlled device through the established socket connection to set a parameter of the controlled device or control the controlled device. The control information includes the control command and the authentication parameter. The control command may be command information including a setting parameter or control parameter of the controlled device. The authentication parameter may include the authorization information and the physical address of the mobile control device.

S8: The controlled device verifies the authorization information in the authentication parameter, and executes the control command in response to verification success and returns verification failure otherwise.

In this embodiment, the controlled device may determine the stored authorization information of the mobile control device corresponding to the received physical address of the mobile control device according to the physical address, and perform the authentication on the received authorization information according to the stored authorization information. If the verification is successful, it indicates that the mobile control device is a legal device and the control command is a valid command, and the controlled device executes the control command, for example, resets a parameter according to a content of the control command to facilitate medical detection; otherwise, it returns the verification failure.

In an optional embodiment, verifying, by the controlled device, the authorization information in the authentication parameter may further include the following operations.

1) The controlled device compares the stored authorization information of the mobile control device with the authorization information in the authentication parameter.

In this embodiment, the controlled device may compare the stored authorization information with the received authorization information in the authentication parameter.

2) In response to the stored authorization information of the mobile control device being the same as the authorization information in the authentication parameter, a timeout verification is performed, that is, the controlled device compares the stored first receiving time with a second receiving time when the control information is received, determines whether the first receiving time and the second receiving time satisfy a preset time range, and executes the control command in response to the first receiving time and the second receiving time satisfying the preset time range and returns the verification failure otherwise.

In this embodiment, the controlled device may compare the stored first receiving time when the mobile control device is connected to acquire the authorization information with the second receiving time when the control information is currently received according to a preset timeout time range. If a time difference between the second receiving time when the mobile control device sends the control information at the present time and the first receiving time satisfies the timeout time range, it indicates that the mobile control device is a legal device and the control command is a valid command, and the controlled device may execute the control command to facilitate medical detection; otherwise, it returns the verification failure and does not execute the control command.

3) In response to the stored authorization information of the mobile control device being different from the authorization information in the authentication parameter, it returns the verification failure.

In this embodiment, if the authorization information in the authentication parameter sent from the mobile control device is inconsistent with the authorization information stored in the controlled device, the mobile control device is considered to be an illegal device, and it returns the verification failure and the control command is not executed. In this way, an illegal device may be effectively prevented from accessing the controlled device and remotely controlling the controlled device maliciously.

So far, the controlled device and the mobile control device complete the authentication process through the socket connection, to realize the remote control of the controlled device by the mobile control device according to the authentication result. In this embodiment, during control of the controlled device by the mobile control device, the authorization information is acquired through the Bluetooth near field connection, combined with the convenience and bandwidth advantages of the socket connection, which solves the communication security problem between the mobile control device and the controlled device, prevents an illegal mobile control device from remotely controlling the controlled device maliciously, and thus has a wide application prospect.

It is worth noting that the above embodiments are only used to illustrate an application scenario of the present disclosure, and the security verification method provided in the present disclosure may also be used in other application scenarios, such as remote control of a smart home appliance, etc. The smart home appliance controlled determines the legality of an accessed mobile control device through short-range wireless communication technology, and generates authorization information based on an identity identifier that uniquely identifies the mobile control device. Within a predefined time range, the mobile control device connects with the controlled smart home appliance according to the authorization information through a socket, and the authorization information sent from the mobile control device is authenticated by the controlled smart home appliance to determine the legality of the mobile control device and execute a control command sent from the mobile control device. That is, the authorization through the short-range wireless communication is combined with the authentication after the socket connection to verify the mobile control device, so as to realize safe and reliable communication.

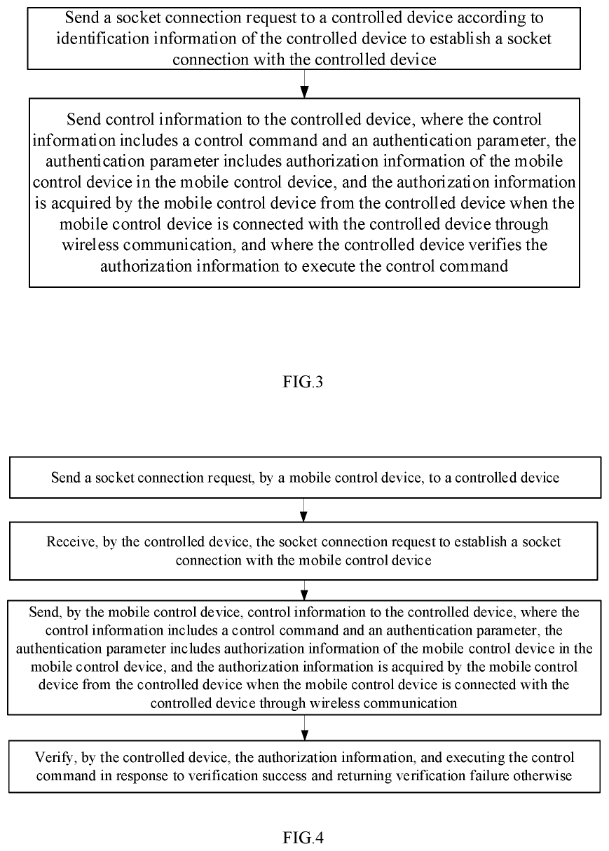

Based on the above embodiments, as shown in FIG. 3, an embodiment of the present disclosure also provides a security verification method applied to a mobile control device, including: sending a socket connection request to a controlled device according to identification information of the controlled device to establish a socket connection with the controlled device; and sending control information to the controlled device, where the control information includes a control command and an authentication parameter, the authentication parameter includes authorization information of the mobile control device in the mobile control device, and the authorization information is acquired by the mobile control device from the controlled device when the mobile control device is connected with the controlled device through wireless communication technology, and where the controlled device verifies the authorization information to execute the control command.

In an optional embodiment, before sending the socket connection request to the controlled device according to the identification information of the controlled device to establish the socket connection with the controlled device, the security verification method may further include: searching for and detecting a wireless communication signal broadcast by the controlled device to be connected, and connecting with the controlled device; transmitting an identity identifier to the controlled device, such that the controlled device generates and stores the authorization information of the mobile control device according to the identity identifier; and receiving and storing the authorization information and the identification information representing an identity of the controlled device from the controlled device.

Similarly, as shown in FIG. 4, an embodiment of the present disclosure further provides a security verification method, including: sending a socket connection request, by a mobile control device, to a controlled device; receiving, by the controlled device, the socket connection request to establish a socket connection with the mobile control device; sending, by the mobile control device, control information to the controlled device, where the control information includes a control command and an authentication parameter, the authentication parameter includes authorization information of the mobile control device in the mobile control device, and the authorization information is acquired by the mobile control device from the controlled device when the mobile control device is connected with the controlled device through wireless communication technology; and verifying, by the controlled device, the authorization information, and executing the control command in response to verification success and returning verification failure otherwise.

In an optional embodiment, before sending the socket connection request, by the mobile control device, to the controlled device, the security verification method may further include: broadcasting, by the controlled device, a wireless communication signal; searching for and detecting, by the mobile control device, the wireless communication signal broadcast by the controlled device to be connected, and connecting with the controlled device; transmitting, by the mobile control device, an identity identifier to the controlled device; generating and storing, by the controlled device, the authorization information of the mobile control device according to the identity identifier; and sending, by the controlled device, the authorization information and identification information representing an identity of the controlled device, to the mobile control device.

In an optional embodiment, generating and storing, by the controlled device, the authorization information of the mobile control device according to the identity identifier, may further include: generating, by the controlled device, a signature of the mobile control device according to the identity identifier and a first receiving time when the identity identifier is received; storing, by the controlled device, the signature and the first receiving time; and generating and storing, by the controlled device, the authorization information according to the signature.

In an optional embodiment, generating and storing, by the controlled device, the authorization information according to the signature, may further include: generating, by the controlled device, a first encrypted signature according to the signature through a message digest algorithm; generating, by the controlled device, an encrypted random number according to a randomly generated random number through the message digest algorithm, and generating a second encrypted signature in combination with the first encrypted signature; and generating and storing, by the controlled device, the authorization information according to the second encrypted signature through the message digest algorithm.

In an optional embodiment, before storing, by the controlled device, the signature and the first receiving time, the security verification method may further include: determining, by the controlled device, whether the signature, the first receiving time and the authorization information of the mobile control device are stored, and in response to determining that the signature, the first receiving time and the authorization information of the mobile control device are stored, deleting the signature, the first receiving time and the authorization information stored.

In an optional embodiment, verifying, by the controlled device, the authorization information, and executing the control command in response to verification success and returning verification failure otherwise, may further include: comparing, by the controlled device, the stored authorization information of the mobile control device with the authorization information in the authentication parameter; in response to the stored authorization information of the mobile control device being the same as the authorization information in the authentication parameter, comparing, by the controlled device, the stored first receiving time with a second receiving time when the control information is received, and executing the control command in response to the first receiving time and the second receiving time satisfying a preset time range and returning the verification failure otherwise; and in response to the stored authorization information of the mobile control device being different from the authorization information in the authentication parameter, returning the verification failure.

In an optional embodiment, the wireless communication technology may be one of Bluetooth, ZigBee, Lora, radio frequency near field communication, and infrared communication.

Corresponding to the security verification method according to the above embodiments, an embodiment of the present disclosure also provides a security verification system. Since the security verification system according to the embodiment of the present disclosure corresponds to the security verification method according to the above embodiments, the previous embodiments are also applicable to the security verification system according to this embodiment, and will not be described in detail herein.

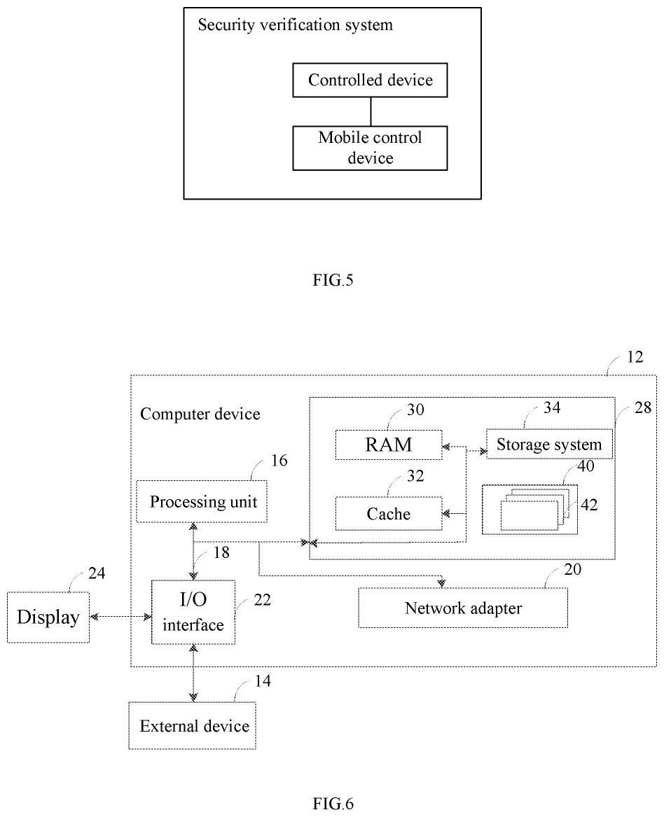

As shown in FIG. 5, an embodiment of the present disclosure also provides a security verification system including a controlled device and a mobile control device. The mobile control device is configured to send a socket connection request to the controlled device to establish a socket connection with the controlled device, and send control information to the controlled device, where the control information includes a control command and an authentication parameter, the authentication parameter includes authorization information of the mobile control device in the mobile control device, and the authorization information is acquired by the mobile control device from the controlled device when the mobile control device is connected with the controlled device through wireless communication technology. The controlled device is configured to verify the authorization information, and execute the control command in response to verification success and return verification failure otherwise.

Another embodiment of the present disclosure provides a non-transitory computer-readable storage medium in which a computer program is stored. The computer program, when executed by a processor, causes the processor to: receive a socket connection request from a mobile control device to establish a socket connection with the mobile control device; receive control information from the mobile control device, where the control information includes a control command and an authentication parameter, the authentication parameter includes authorization information of the mobile control device in the mobile control device, and the authorization information is acquired by the mobile control device from the controlled device when the mobile control device is connected with the controlled device through wireless communication technology; and verify the authorization information, and executing the control command in response to verification success and returning verification failure otherwise.

Another embodiment of the present disclosure provides a non-transitory computer-readable storage medium in which a computer program is stored. The computer program, when executed by a processor, causes the processor to: send a socket connection request to a controlled device according to identification information of the controlled device to establish a socket connection with the controlled device; and send control information to the controlled device, where the control information includes a control command and an authentication parameter, the authentication parameter includes authorization information of the mobile control device in the mobile control device, and the authorization information is acquired by the mobile control device from the controlled device when the mobile control device is connected with the controlled device through wireless communication technology, such that the controlled device verifies the authorization information to execute the control command.

In practical applications, the computer-readable storage medium may be any combination of one or more computer-readable media. The computer-readable media may be computer-readable signal media or computer-readable storage media. The computer-readable storage media may be, for example, but not limited to, electrical, magnetic, optical, electromagnetic, infrared, or semiconductor systems, apparatuses or devices, or any combination thereof. More specific examples (a non-exhaustive list) of the computer-readable storage media may include: electrical connections with one or more wires, portable computer disks, hard disks, random access memories (RAMs), read-only memories (ROMs), erasable programmable read-only memories (EPROMs or flash memories), optical fibers, portable compact disk read-only memories (CD-ROMs), optical storage devices, magnetic storage devices, or any suitable combination thereof In this embodiment, the computer-readable storage media may be any tangible media that contain or store a program, which may be used by or in combination with an instruction execution system, apparatus, or device.

The computer-readable signal media may include data signals propagated in baseband or as a part of a carrier wave, in which computer-readable program codes are carried. The data signals propagated as such may be in many forms, including but not limited to electromagnetic signals, optical signals, or any suitable combination thereof. The computer-readable signal media may also be any computer-readable media other than the computer-readable storage media, which may send, propagate, or transmit the program for use by or in combination with the instruction execution system, apparatus, or device.

The program codes contained in the computer-readable media may be transmitted by any suitable medium, including but not limited to wireless, wire, optical cable, RF, etc., or any suitable combination thereof

The computer program codes used to perform the operations in the present disclosure may be written in one or more programming languages or a combination thereof. The programming languages include object-oriented programming languages such as Java, Smalltalk, C++, and also include conventional procedural programming languages such as “C” language or similar programming languages. The program codes may be executed completely on a user's computer, executed partially on the user's computer, executed as an independent software package, executed partially on the user's computer and partially on a remote computer, or executed completely on the remote computer or server. In the case of the remote computer, the remote computer may be connected to the user's computer through any kind of network, including a local area network (LAN) or a wide area network (WAN), or may be connected to an external computer (for example, through the Internet using an Internet service provider).

As shown in FIG. 6, FIG. 6 illustrates a schematic structural diagram of a computer device according to another embodiment of the present disclosure. The computer device 12 shown in FIG. 6 is merely an example, and should not bring any limitation to the function and scope of use of the embodiments of the present disclosure.

As shown in FIG. 6, the computer device 12 takes the form of a general-purpose computing device. Components of the computer device 12 may include, but are not limited to: one or more processors or processing units 16, a system memory 28, and a bus 18 connecting different system components (including the system memory 28 and the processing units 16).

The bus 18 represents one or more of several types of bus structures, including a memory bus or a memory controller, a peripheral bus, a graphics acceleration port, a processor, or a local bus using any bus structure of multiple bus structures. For example, these architectures include, but are not limited to, industry standard architecture (ISA) bus, micro channel architecture (MAC) bus, enhanced ISA bus, video electronics standards association (VESA) local bus, and peripheral component interconnection (PCI) bus.

The computer device 12 typically includes a variety of computer system readable media. These media may be any available media that can be accessed by the computer device 12, including volatile and non-volatile media, and removable and non-removable media.

The system memory 28 may include a computer system readable medium in the form of a volatile memory, such as a random access memory (RAM) 30 and/or a cache memory 32. The computer device 12 may further include other removable/non-removable, volatile/non-volatile computer system storage media. For example only, a storage system 34 may be used to read and write non-removable, non-volatile magnetic media (not shown in FIG. 6, but generally referred to as “hard disk drive”). Although not shown in FIG. 6, a magnetic disk drive for reading and writing to a removable non-volatile magnetic disk (such as “floppy disk”) and an optical disk drive for reading and writing to a removable non-volatile optical disk (such as CD-ROM, DVD-ROM or other optical media) may be provided. In these cases, each drive may be connected with the bus 18 through one or more data medium interfaces. The memory 28 may include at least one program product having a set of program modules (for example, at least one program module), which are configured to perform the functions of various embodiments of the present disclosure.

A program/utility tool 40 having a set of (at least one) program modules 42 may be stored in, for example, the memory 28. Such program modules 42 include but are not limited to an operating system, one or more application programs, other program modules, and program data. Each or some combination of these examples may include an implementation of a network environment. The program modules 42 generally execute the functions and/or methods in the embodiments described in the present disclosure.

The computer device 12 may communicate with one or more external devices 14 (such as keyboards, pointing devices, and displays 24), and may also communicate with one or more devices that enable users to interact with the computer device 12, and/or communicate with any device (such as a network card, and a modem) that enables the computer device 12 to communicate with one or more other computing devices. Such communication may be performed through an input/output (I/O) interface 22. In addition, the computer device 12 may also communicate with one or more networks (for example, a local area network (LAN), a wide area network (WAN), and/or a public network such as the Internet) through a network adapter 20. As shown in FIG. 6, the network adapter 20 communicates with other modules of the computer device 12 through the bus 18. It should be understood that though not shown in FIG. 6, other hardware and/or software modules may be used in conjunction with the computer device 12, including but not limited to: microcode, device drivers, redundant processing units, external disk drive arrays, RAID systems, tape drives and data backup storage systems, etc.

The processing units 16 execute various functional applications and data processing by running programs stored in the system memory 28, for example, to implement the security verification method according to the embodiments of the present disclosure.

In view of the current existing problems, the present disclosure formulates a security verification method, a security verification system, a computer-readable storage medium and a computer device. Authorization information is acquired through a wireless communication connection, and verification is performed according to the authorization information during a socket connection, to solve the malicious control problem in the existing remote control of the controlled device, thereby enabling a mobile control device to access the controlled device safely and stably, and set and control the controlled device safely and stably.

Obviously, the above embodiments of the present disclosure are merely examples to clearly illustrate the present disclosure, and are not intended to limit the embodiments of the present disclosure. For those ordinary skilled in the art, other changes or modifications in different forms may be made on the basis of the above description. It is impossible to exhaustively list all the embodiments here, and any obvious changes or modifications derived from the technical solutions of the present disclosure are still within the protection scope of the present disclosure.

1. A security verification method for a communication device, which is applied to a controlled device, the method comprising:
receiving a socket connection request from a mobile control device to establish a socket connection with the mobile control device;
receiving control information from the mobile control device, wherein the control information comprises a control command and an authentication parameter, the authentication parameter comprises authorization information of the mobile control device in the mobile control device, and the authorization information is acquired by the mobile control device from the controlled device when the mobile control device is connected with the controlled device through wireless communication technology; and
verifying the authorization information, and executing the control command in response to verification success and returning verification failure otherwise.

2. The security verification method according to claim 1, wherein before receiving the socket connection request from the mobile control device to establish the socket connection with the mobile control device, the security verification method further comprises:
broadcasting a wireless communication signal;
receiving an identity identifier of the mobile control device;
generating and storing the authorization information of the mobile control device according to the identity identifier; and
sending the authorization information and identification information representing an identity of the controlled device to the mobile control device.

3. The security verification method according to claim 2, wherein generating and storing the authorization information of the mobile control device according to the identity identifier further comprises:
generating a signature of the mobile control device according to the identity identifier and a first receiving time when the identity identifier is received;
storing the signature and the first receiving time; and
generating and storing the authorization information according to the signature.

4. The security verification method according to claim 3, wherein generating and storing the authorization information according to the signature further comprises:
generating a first encrypted signature according to the signature through a message digest algorithm;
generating an encrypted random number according to a randomly generated random number through the message digest algorithm, and generating a second encrypted signature according to the encrypted random number in combination with the first encrypted signature; and
generating and storing the authorization information according to the second encrypted signature through the message digest algorithm.

5. The security verification method according to claim 3, wherein before storing the signature and the first receiving time, the security verification method further comprises:
determining whether the signature and the authorization information of the mobile control device and the first receiving time are stored, and in response to determining that the signature and the authorization information of the mobile control device and the first receiving time are stored, deleting the signature, the first receiving time and the authorization information stored.

6. The security verification method according to claim 5, wherein verifying the authorization information, and executing the control command in response to verification success and returning verification failure otherwise, further comprises:
comparing the stored authorization information of the mobile control device with the authorization information in the authentication parameter;
in response to the stored authorization information of the mobile control device being the same as the authorization information in the authentication parameter, comparing the stored first receiving time with a second receiving time when the control information is received, and executing the control command in response to the first receiving time and the second receiving time satisfying a preset time range and returning the verification failure otherwise; and
in response to the stored authorization information of the mobile control device being different from the authorization information in the authentication parameter, returning the verification failure.

7. The security verification method according to claim 6, wherein the wireless communication is one of Bluetooth, ZigBee, Lora, radio frequency near field communication, and infrared communication.

8. A security verification method, which is applied to a mobile control device, the method comprising:
sending a socket connection request to a controlled device according to identification information of the controlled device to establish a socket connection with the controlled device; and
sending control information to the controlled device, wherein the control information comprises a control command and an authentication parameter, the authentication parameter comprises authorization information of the mobile control device in the mobile control device, and the authorization information is acquired by the mobile control device from the controlled device when the mobile control device is connected with the controlled device through wireless communication and wherein the controlled device verifies the authorization information to execute the control command.

9. The security verification method according to claim 8, wherein before sending the socket connection request to the controlled device according to the identification information of the controlled device to establish the socket connection with the controlled device, the security verification method further comprises:
searching for and detecting a wireless communication signal broadcast by the controlled device to be connected, and connecting with the controlled device;
transmitting an identity identifier to the controlled device through the wireless communication signal, such that the controlled device generates and stores the authorization information of the mobile control device according to the identity identifier; and
receiving and storing the authorization information and the identification information representing an identity of the controlled device from the controlled device.

10. A security verification method, comprising:
sending a socket connection request, by a mobile control device, to a controlled device;
receiving, by the controlled device, the socket connection request to establish a socket connection with the mobile control device;
sending, by the mobile control device, control information to the controlled device, wherein the control information comprises a control command and an authentication parameter, the authentication parameter comprises authorization information of the mobile control device in the mobile control device, and the authorization information is acquired by the mobile control device from the controlled device when the mobile control device is connected with the controlled device through wireless communication and
verifying, by the controlled device, the authorization information, and executing the control command in response to verification success and returning verification failure otherwise.

11. The security verification method according to claim 10, wherein before sending the socket connection request, by the mobile control device, to the controlled device, the security verification method further comprises:
broadcasting, by the controlled device, a wireless communication signal;
searching for and detecting, by the mobile control device, the wireless communication signal broadcast by the controlled device to be connected, and connecting with the controlled device;
transmitting, by the mobile control device, an identity identifier to the controlled device;
generating and storing, by the controlled device, the authorization information of the mobile control device according to the identity identifier; and
sending, by the controlled device, the authorization information and identification information representing an identity of the controlled device, to the mobile control device.

12. The security verification method according to claim 11, wherein generating and storing, by the controlled device, the authorization information of the mobile control device according to the identity identifier, further comprises:
generating, by the controlled device, a signature of the mobile control device according to the identity identifier and a first receiving time when the identity identifier is received;
storing, by the controlled device, the signature and the first receiving time; and
generating and storing, by the controlled device, the authorization information according to the signature.

13. The security verification method according to claim 12, wherein generating and storing, by the controlled device, the authorization information according to the signature, further comprises:
generating, by the controlled device, a first encrypted signature according to the signature through a message digest algorithm;
generating, by the controlled device, an encrypted random number according to a randomly generated random number through the message digest algorithm, and generating a second encrypted signature according to the encrypted random number in combination with the first encrypted signature; and
generating and storing, by the controlled device, the authorization information according to the second encrypted signature through the message digest algorithm.

14. The security verification method according to claim 12, wherein before storing, by the controlled device, the signature and the first receiving time, the security verification method further comprises:
determining, by the controlled device, whether the signature and the authorization information of the mobile control device and the first receiving time are stored, and in response to determining that the signature and the authorization information of the mobile control device and the first receiving time are stored, deleting the signature, the first receiving time and the authorization information stored.

15. The security verification method according to claim 10, wherein verifying, by the controlled device, the authorization information, and executing the control command in response to verification success and returning verification failure otherwise, further comprises:
comparing, by the controlled device, the stored authorization information of the mobile control device with the authorization information in the authentication parameter;
in response to the stored authorization information of the mobile control device being the same as the authorization information in the authentication parameter, comparing, by the controlled device, the stored first receiving time with a second receiving time when the control information is received, and executing the control command in response to the first receiving time and the second receiving time satisfying a preset time range and returning the verification failure otherwise; and
in response to the stored authorization information of the mobile control device being different from the authorization information in the authentication parameter, returning the verification failure.

16. The security verification method according to claim 10, wherein the wireless communication is one of Bluetooth, ZigBee, Lora, radio frequency near field communication, and infrared communication.

17. A security verification system, comprising a controlled device and a mobile control device, wherein
the mobile control device is configured to send a socket connection request to the controlled device to establish a socket connection with the controlled device, and send control information to the controlled device, wherein the control information comprises a control command and an authentication parameter, the authentication parameter comprises authorization information of the mobile control device in the mobile control device, and the authorization information is acquired by the mobile control device from the controlled device when the mobile control device is connected with the controlled device through wireless communication and
the controlled device is configured to perform the security verification method according to claim 1.

18. (canceled)

19. A computer device, comprising a memory, a processor, and a computer program stored in the memory and executable in the processor, wherein the processor performs the security verification method according to claim 1 when executing the computer program.

20. A computer device, comprising a memory, a processor, and a computer program stored in the memory and executable in the processor, wherein
the processor performs the security verification method according to claim 8 when executing the computer program.
